(19) United States
(12) Patent Application Publication
(10) Pub. No.: US 2010/0212183 A1
(43) Pub. Date: Aug. 26, 2010

(54) BOOT LINER

(75) Inventors: Sven Seliger, Soll (AT); Gerald Rosner, Kapellendorf (DE)

Correspondence Address: MICHAEL BEST & FRIEDRICH LLP, 100 E WISCONSIN AVENUE, Suite 3300, MILWAUKEE, WI, 53202, US

(73) Assignee: DEELUXE SPORTARTIKEL HANDELS GMBH, Kufstein (AT)

(21) Appl. No.: 12/523,413

(22) PCT Filed: Dec. 27, 2007
(86) PCT No.: PCT/EP2007/011434

§ 371 Date: Apr. 15, 2010

(30) Foreign Application Priority Data
Jan. 17, 2007 (DE) 10 2007 002 335.0

(51) Int. Cl. A43B 7/02; H05B 3/00

(52) U.S. Cl. 36/2.6; 219/211

(57) ABSTRACT

A boot liner, for a ski boot, snowboarding boot, inline skating boot, mountaineering boot or the like, which boot liner is made, at least in a sub-region, of a material which is plastically deformable at a predetermined temperature (the deformation temperature (T_{V})), there being associated at least with the plastically deformable sub-region of the boot liner a woven or knitted planiform electrical heating element, by means of which at least the mentioned sub-region is heatable to the deformation temperature (T_{V}).

### RELATED APPLICATIONS

This is a national phase application under 35 U.S.C. §371 of International Patent Application No. PCT/EP2007/011434 filed on Dec. 27, 2007, which claims priority to German Patent Application No. 10 2007 002 335.0 filed on Jan. 17, 2007, the entire contents of both of which are incorporated herein by reference.

### BACKGROUND

The present invention relates to a boot liner, for a ski boot, snowboarding boot, inline skating boot, mountaineering boot or the like.

Boot liners of the afore-mentioned kind are known from the prior art. For example, the Raichle company almost a decade ago produced a so-called “ThermoFlex” boot liner distinguished by the fact that it was made of a thermally deformable material. The boot liner made of such a material had to be heated for ten minutes in an oven at about 120 degrees Celsius. The wearer then had to slip his foot into the boot liner and fasten the selected ski boot. After about 5 minutes the liner assumed a tailor-made fitting shape. Subsequent modification was also possible by heating the boot liner again in an oven at about 120° C. for about ten minutes. The boot liner could then be re-adapted to the foot in the prescribed manner.

U.S. Pat. No. 5,673,448 and DE 69807045 T2 show a similarly deformable boot liner made of a thermoplastic material. A boot liner of such a kind which is plastically deformable under the influence of temperature is also to be found in WO98/54997 A1.

The underlying disadvantage of all the mentioned liners is that adaptation can be carried out only by means of heating in an oven. The liner accordingly has to be pre-heated in an oven and it then has to be put on by the wearer in the hot state and inserted into the associated ski boot, mountaineering boot or like outer boot, depending on the use of the boot liner. In this case it is disadvantageous that, in particular, this insertion of the liner in the heated state can be very unpleasant, especially for the wearer. In addition, it has been found that, because of the reduced rigidity of the material in the heated state, the desired fitting shape is sometimes not achieved because the boot liner slips when the boot liner is being inserted into the outer boot.

### SUMMARY OF THE INVENTION

Starting from that prior art, the present invention is based on the problem of providing a boot liner of the kind mentioned at the beginning which is simpler, more effective and, furthermore, more conveniently thermoplastically deformable and, especially, adaptable to the wearer's foot.

The problem is accordingly solved especially by the fact that the boot liner for a ski boot, snowboarding boot, inline skating boot, mountaineering boot or the like, which boot liner is made, at least in a sub-region, of a material which is plastically deformable at a predetermined temperature, has at least one woven or knitted planiform electrical heating element associated with the plastically deformable sub region of the boot liner, by means of which heating element at least the mentioned sub-region is heatable to the deformation temperature.

Accordingly, by means of the associated planar electrical heating element, at least the thermoplastic regions of the boot liner can be heated in such manner that they undergo plastic deformation. Heating of the boot liner in an oven, as is necessary in the case of the above-described prior art, becomes unnecessary as a result. At the same time, the invention is suitable for heating to a so-called comfort temperature of greater than or equal to 28 degrees Celsius.

Because, furthermore, the heating element can be arranged on or in the boot liner both over the whole area or also, however, only in sub-regions, it is now also possible, in contrast to the prior art, for only particular regions to be heated up so that they undergo plastic deformation. Depending on requirements, it is accordingly possible for heating elements to be arranged in, for example, the sole region, the heel region, ball region or also, however, in the upper of the boot liner etc.

Formation of the heating element as a woven or knitted planar electrical heating element moreover facilitates integration or positioning of the heating element on the boot liner. Especially in the case of the plastic deformation of the heated regions, a “soft and flexible” material of such a kind is very advantageous because it does not result in undesirable deformations caused by its intrinsic tension. The heating element according to the invention also ensures optimum adaptation of the boot liner to the foot.

Preferably, the heating element is made of an electrically conductive thread material which is incorporated in a heating element carrier fabric. This makes possible very flexible production of a planar heating element, it being possible for the heating element carrier fabric to be any fabric known from the prior art, that is to say, for example, a woven or knitted fabric. The above definition also includes arrangements of the heating element wherein the electrically conductive thread material is woven or knitted together with a non-conductive thread material in order to obtain a corresponding plane-form element. In principle the objective is to combine the electrically conductive thread material with the heating element carrier fabric, that is to say a heating element carrier fabric weave or knit etc., individual non-conductive thread materials or like heating element carrier fabrics in such a way that particular regions of the heating element are made of electrically conductive thread material but other regions are made of the non-conductive heating element carrier fabric. In this regard, reference is made especially to EP 1 705 956 A1, which belongs to the Applicant.

Preferably, the heating element has at least one heating region and at least one current-conducting region, the latter serving for connection of the heating element to a source of current and/or for joining up a plurality of heating elements, and the electrically conductive thread material being incorporated in a greater density in the current-conducting region than in the heating region. Because the same or at least a similar electrically conductive thread material is used in the heating region, but the incorporation density of the thread material is considerably greater in the current region than in the heating region, the current region heats up less because of the resultant overall electrical resistance. A current supply to the heating region without substantial self-heating and, moreover, without substantial losses becomes readily possible as a result. As a result of the reduced thread material density in the heating region, however, the resultant overall resistance there is very high so that heating up of those regions occurs. Depending on the connected source of current, the cross-sections and conductivity of the thread materials, it is accordingly possible by suitable selection of the distribution density to define the temperature in the heating region and in the current-conducting region. It is also possible by this means to join up a plurality of heating regions to one another by way of current-conducting regions. If the intention in the case of the boot liner according to the invention is, for example, for only the region of the toes and/or of the heel to be heated and especially to undergo thermoplastic deformation, it is accordingly possible to arrange heating regions in those regions and to join them up by way of current-conducting regions which, because of that very low overall resistance, do not produce any heating power.

Preferably, the heating element is so constructed that at least the mentioned sub-region of the boot liner is also heatable, in addition to the deformation temperature, substantially to a heating temperature T_{HZ} of, especially, 35-60 degrees Celsius. As a result, the heating element provided principally for deformation of the thermoplastic material of the boot liner can also be used for heating the boot liner and especially for heating the boot liner during use. The mentioned heating temperature range therein is the range which according to experience is felt by a wearer as being pleasant. Of course, however, other temperature ranges can also be set in this case, should this be necessary.

Preferably, the heating element has, at predetermined locations, heating regions, distributed over the boot liner, in which regions the electrically conductive thread material has been incorporated, at least in part, in varying density. This makes it possible to construct the boot liner with different heating regions having different heating power. Depending on the density of the incorporated conductive thread materials, it is possible, for example, for toe regions, heel regions, the sole of the boot liner or also, however, the upper to be heated up to varying degrees. This is advantageous especially when the thermoplastically deformable boot liner is constructed using boot liner materials of different thicknesses, but also furthermore when the heating element is used in heating operation, that is to say for the heating of a boot liner for a ski boot, for example when skiing, or for drying it.

Preferably, the heating element comprises a plurality of independent heating circuits, formed from electrically conductive thread materials, which, especially separately and/or in combination with one another, are connectible to a source of current and/or arranged to be supplied therefrom. By that means, as a result of interconnection of the separately running heating circuits, the heating power can be modified. It is also possible by that means, for example, to provide specific heating circuits for the thermoplastic deformation and specific heating circuits for heating before, after or during use of the boot liner. In this case it is also feasible to use appropriate switching elements which are especially integrated in the boot liner and which allow switching-over between the individual heating circuits. In this context it is of course also possible for heating circuits to be so arranged that, especially by means of a switching device, only specific regions in the boot liner are heated, when this is desired. This applies of course both to the thermoplastic deformation procedure and also to the operation of heating to the afore-mentioned body compatible temperature.

Preferably, the electrically conductive thread material is based on natural and/or synthetic fibres or filaments and is made electrically conductive by means of metal additions (for example, silver treatment) or similar treatment methods without metal threads or metal fibres. This arrangement constitutes an especially advantageous heating element structure, because metal fibres and/or metal threads in particular have a disadvantageous effect on the rigidity of the fabric. Said threads are known, for example, from the prior art and also especially in this case from use in antistatic carpets. They preferably have a textile feel in order to simplify their processing. The thread material can also be made of, for example, polyester with embedded carbon so that it is electrically conductive.

Preferably, the heating element, and especially at least one current-conducting region, has at least one connection element, which is led out especially at least to the outside of the boot liner, for connection of the source of current, especially of a battery or a cable-connected transformer. A connection element is understood herein to be any connection element known from the prior art, for example plugs, couplings, push couplings or also, however, connection elements which are connected to the current-conducting region by way of a cable. For example, it is advantageous when a battery is used with the heating element for the battery to be connected to the current-conducting region by way of an especially coiled or length-adaptable connection cable so that the battery can then be attached at suitable locations. For the purpose it is advantageous inter alia for an attachment device to be constructed on the boot liner. However, it is of course also feasible to construct appropriate attachment devices on the outer boot, that is to say a ski boot, mountaineering boot etc., or on the wearer's body itself.

In this context it is relevant that the heating element is advantageously so constructed that in the case of operation with the battery it is heatable merely to the afore-mentioned heating temperature suitable for the body of, especially, 25-35 degrees Celsius and in the case of operation with, for example, a cable-connected transformer, which can be connected to a 230 volt mains supply, can be heated up to the deformation temperature mentioned hereinbefore of, especially, 100-120 degrees Celsius. On the one hand this reduces the size of the battery because it has to produce the output that is required merely for the heating operation; on the other hand, however, it prevents unintentional heating of the boot liner to the deformation temperature, especially in the course of operation.

Preferably, there is provided an open-loop and/or closed-loop control device, especially integrated in the boot liner, for controlling the heating element and its temperature development and especially the current flowing from the source of current to the heating element and/or flowing in the heating element. By that means, the heating operation can be switched on or stopped and, depending on the arrangement of the open-loop and/or closed-loop control device, the heating temperature can be raised or lowered. In this context, any open-loop and/or closed-loop control devices known from the prior art can be used. In this case, the use of wireless open-loop and/or closed-loop control devices is also especially applicable for controlling the heating element. This of course also applies to the use of appropriate sensors in order to detect, especially, the temperature in the boot liner. This is possible directly, by means of temperature sensors, or also, however, by means of current flow sensors in the open-loop and/or closed-loop control device, in the source of current or in a similar component.

In addition, it is further possible to provide appropriate display devices which, for example, signal when the desired thermoplastic temperature has been reached or also, however, to provide displays which indicate that the boot liner according to the invention has already been heated to the deformation temperature on one, two or more occasions before. This prevents inter alia thermoplastic deformation, when the thermoplastic deformability of the liner (which experience has shown to decrease) is threatening to decrease because of heating having already been carried out a number of times before. In this case too, any display and signal devices known from the prior art, of either dynamic or static kind, are feasible.

In the case of a boot liner made of an especially multi-layered basic material, the electrical heating element is preferably integrated into the basic material. This is possible both in the case of a single-layer basic material, for example a foam liner, in which the heating element is incorporated during foam formation or onto which the heating element is applied, or also, however, in the case of a multi-layer liner, in which the heating element can be integrated especially in the contact regions of the individual layers or also, however, in an individual layer.

Preferably, the heating element is at least in part integrated into an especially textile inner lining of the boot liner and/or is associated therewith. In this case it is firstly possible for the heating element to be applied on the inner lining so that, for example, the inner lining part is facing the inside of the boot liner but it is also possible for the inner lining itself to be formed at least in part from the electrically conductive thread materials of the heating element. Here too reference is made to EP 1 705 956 A1.

Preferably, there is provided, between the heating element and/or the outside of the boot liner, a thermally insulating, especially thermally reflective, layer in order to prevent unused heating power being radiated out to the surroundings. By that means, the heating energy required to heat up the heating element to the deformation temperature and/or heating temperature is reduced many times. In this context, additional insulating and shielding layers can of course also be used.

The invention will be explained hereinbelow by means of examples of embodiments, which are described in further detail with reference to the accompanying drawings.

### BRIEF DESCRIPTION OF THE DRAWINGS

FIGS. 1 and 2 are isometric views of a first embodiment of the boot liner, having an externally located heating element;

FIGS. 3 and 4 are isometric views of a second embodiment of the boot liner, having an externally located heating element;

FIG. 5 is a partial cross-section through a third embodiment of the boot liner, having a centrally located heating element; and

FIG. 6 shows a fourth embodiment of the boot liner, having an internally located heating element.

### DETAILED DESCRIPTION

The same reference numerals are used hereinbelow for components that are the same and that have the same effect, with superscript indices sometimes being used to distinguish like components.

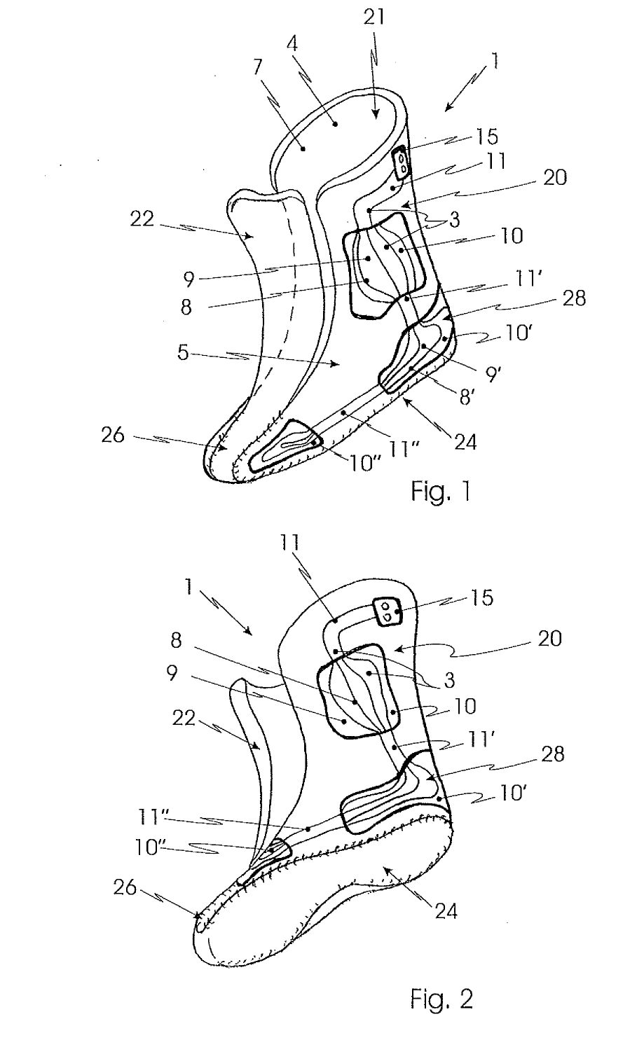

FIGS. 1 and 2 show a first embodiment of the boot liner 1 according to the invention. In this case it is made of a basic material 4 of foam, to which an inner lining 7 has been applied in the inner region 21 of the boot liner 1. The boot liner 1 in this case is made, by way of example, from an upper 20 and a tongue 22 which, by way of a forefoot region 26 and a heel region 28, merge into a sole region 24.

For optimum adaptation of the boot liner 1 to a wearer's foot, it is made at least in part of a thermoplastic basic material 4 which, by means of heating to a predetermined deformation temperature Tᵥ, in this case about 100-120 degrees Celsius, can be made plastically deformable. As soon as the wearer steps into the boot liner 1, the latter starts to adapt to the external contour of the foot. In this case it is possible to provide the boot liner 1 with a plastically deformable material only in particular regions or also, however, as is the case here, for it to be made in its entirety from such a thermoplastic material.

In accordance with the invention, the boot liner 1 has, for heating up to the deformation temperature Tᵥ, a heating element 3, in this case on the outside 5 of the boot liner, which heating element 3 is made of a woven or knitted planar material. In this embodiment, the heating element 3 is made of a heating element carrier fabric 9 into which there is woven an electrically conductive thread material 8. In dependence on the incorporation density of the electrically conductive thread material 8, different regions and especially current-conducting regions 11 and heating regions 10 are formed in the heating element 3.

In the current-conducting region 11, the electrically conductive thread material 8 is distributed with a density such that the overall electrical resistance becomes so low that heating up of the electrically conductive thread material 8 does not come about. In the heating region 10, on the other hand, the density of the electrically conductive thread material 8 is reduced relative to the heating element area so that the overall electrical resistance is increased and, as a result thereof, the individual electrically conductive threads 8 heat up.

In this embodiment, the heating element 3 is applied to the outside 5 of the boot liner 1. It is possible, for example, for the heating element 3 to be adhesively bonded to the outside 5 of the basic material 4 of the boot liner 1 over its entire area. However, it is of course also possible for the heating element 3 to be fastened only pointwise or, however, on specific sides of the heating element 3 and for other sides to be kept flexible. In this case it is also feasible for the heating element 3 to be used as an accommodating mounting for possible lacing of the boot liner 1, as a result of which the heating element 3 would very effectively fit snugly against the external contour or outside 5 of the boot liner 1 when the boot liner 1 is laced up. Of course it is also possible for the heating element 3 to be in the form of a removable heating element, for example in the form of a heating element stocking which can be pulled up over the boot liner 1. This would make it possible, for example, for a single heating element to be used for the thermoplastic deformation of a plurality of liners, which is advantageous especially in sports shops or similar areas, where liners have to be adapted in large numbers. In this context, the electrical heating element 3 is at least in part preferably resiliently constructed in order to ensure adaptation to different boot liners 1.

In this first embodiment, the heating element 3 extends forwards from the region of the upper 20, by way of the heel region 28, to the forefoot 26 or toe region. Heating of the sole 24 is not provided in this embodiment. Furthermore, in this case only dedicated regions are heatable and, therefore, thermally deformable.

As shown, the heating element 3 includes a connection element 15, from which a first heating region 10, especially in the region of the upper 20, is supplied by way of a current-conducting region 11. From there, a second current-conducting region 11′ extends to a second heating region 10′, which substantially covers the heel 28 of the boot liner 1. Finally, a third heating region 10″ in the forefoot region 26 of the boot liner 1 is supplied via a third current-conducting region 11″. Because, as already described hereinbefore, the incorporation density of the electrically conductive thread material 8 has been reduced in the heating regions 10, 10′ and 10″, heating up of the electrically conductive threads 8 occurs in those regions once a current is applied to the connection element 15. Because of the high incorporation density of the electrically conductive thread material 8 in the current-conducting regions 11, 11′ and 11″, on the other hand, the current is passed from the connection element 15 to the respective heating regions 10, 10′ and 10″ without heating up and without large losses. It is of course also possible in this case for further regions of the boot liner 1 also to be provided with heating regions.

Besides use of the heating regions 10 or heating element 3 for thermoplastic deformation of the boot liner 1 or of its basic material 4, the heating element 3 can also be used, however, as an element which heats the boot liner 1, before, during and/or after its use, to a temperature THZ which people consider to be comfortable or bearable. Accordingly it is possible, therefore, to include, by means of the heating element 3, a liner heating system which actively heats the foot, for example when the boot liner 1 is used with a ski boot or snowboarding boot. In this context it is possible to provide the heating regions 10, which in this case are individually constructed, with electrically conductive thread materials 8 in different densities in order to obtain, depending on the region in the liner, for example the heel 28 or the forefoot 26, different heating power in the various heating regions 10 whilst using the same current intensity.

In this context it should also be mentioned that it is of course possible to establish separate power circuits within the heating element 3, which can then be switched on and off manually or automatically by way of an appropriate closed-loop or open-loop control device. Of course it is in general possible for the electrical heating element 3 to be provided with appropriate temperature sensors, signal generators and switching and control devices etc., which make it possible for operation and use both during thermoplastic deformation and also during normal heating to be simplified and subjected to open-loop and/or closed-loop control. In this case, drying programs, automatic deformation programs etc. can also especially be controlled, especially by microchip. As mentioned hereinbefore, it is also possible in this context for appropriate displays to be provided which especially indicate whether and/or how often the boot liner 1 has already been heated to a deformation temperature. In this case, both static and also dynamic displays of any kind can be used.

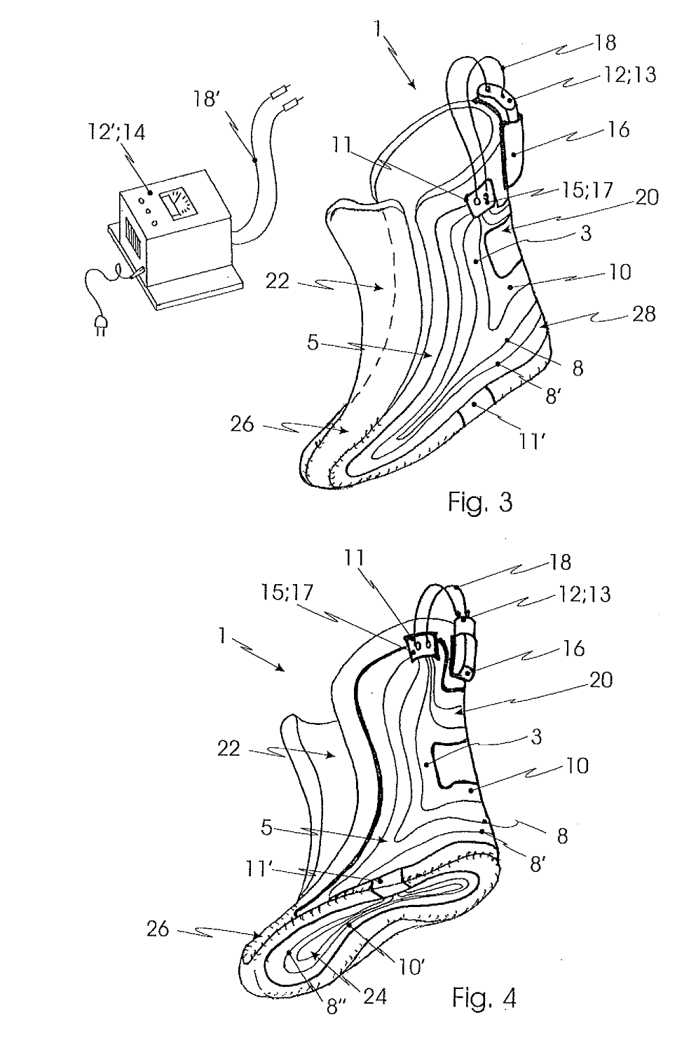

FIGS. 3 and 4 show a second embodiment of the boot liner 1 according to the invention, also in isometric views. In contrast to the first embodiment dealt with hereinbefore, the electrical heating element 3 in this case is applied to substantially the whole area of the outside 5 of the boot liner 1, so that heating over the whole area is brought about. Of course it is also possible in this case, by appropriate integral modification of the incorporation density of the electrically conductive thread material 8, for the heating power to be specifically adapted in the particular regions of the boot liner 1. In addition to the regions of the upper, heel and forefoot 22, 28, 26, the sole 24 is, in this embodiment, also provided with a heating region 10′, which is connected to the heating region 10 by way of a current-conducting region 11′.

Also shown in FIGS. 3 and 4 is a possibility for supplying the heating element 3 with current. In this case there is provided a source of current 12 or battery 13, which can be connected to the connection element 15 by way of appropriate electrical connection means 18, with, in this embodiment, an open-loop/closed-loop control device 17 also being integrated into the connection element 15, especially for subjecting the heating line to closed-loop control. In this case, any sources of current, methods, connection solutions etc. known from the prior art can be used.

In addition, the boot liner 1 has an attachment device 16, which in this case is arranged in the rear region of the upper 20 of the boot liner 1 and which serves to accommodate the battery 13. Also shown is an alternative source of current 12′, in this case a cable-connected transformer 14, which can especially be connected to a 230 V mains. Of course, any other, especially cable-connected, source of current can also be used in this case.

In this embodiment, both sources of current 12, 12′ serve for heating up the boot liner 1. However, because of the different output, and especially in order to prevent unintentional heating up to a deformation temperature TV, the battery 13 serves for the heating operation before, during and/or after use of the boot liner 1, the cable-connected transformer 12′ on the other hand serving for heating to the deformation temperature Tᵥ. However, it is of course also possible, if this should be necessary, to use a battery 13 having an output level such that it is also possible to reach the deformation temperature TV therewith.

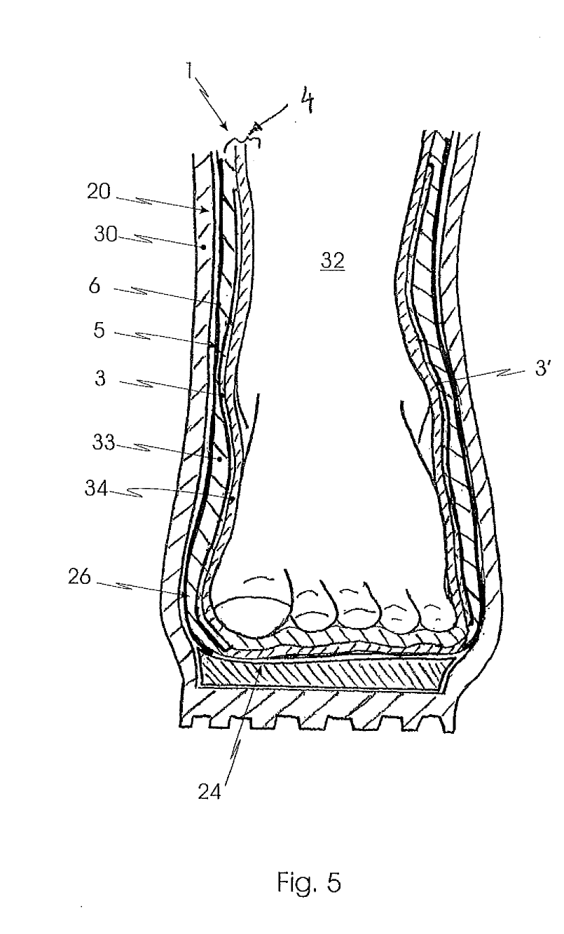

FIG. 5 shows a partial section through a third embodiment of the boot liner 1 according to the invention, with its also being possible for the basic structure shown in this case to be applied to the embodiments shown hereinbefore. In this case the boot liner 1 is made of a multi-layered basic material 4, especially from an outer layer 33 and an inner layer 34, which in this case are made of different, yet still thermoplastically deformable materials. It is accordingly possible, for example, for the outer layer 33 to be constructed as a relatively hard layer, which then acts as a primary supporting layer, and the inner layer 34 to be constructed as a relatively soft, or lining, layer. By way of example, the boot liner 1 has already been inserted in this case into an outer boot 30, for example a ski boot or work boot.

In order, then, to make possible thermoplastic deformation of the boot liner 1 and optimum adaptation to the wearer's foot 32, the heating element 3 is integrated between the outer layer 33 and the inner layer 34 of the basic material 4. In this embodiment, the heating element 3 extends on both sides of the boot liner 1, that is to say from the region of the upper 20 to the forefoot region 26. The sole region 24 is not heatable in this case.

In order to make effective use of the heat generated by the heating element 3, or the heat generated in the heating regions of the heating element 3, a thermally insulating, especially thermally reflective, layer 6 is provided between the heating element 3 and the outside 5 of the boot liner. In this embodiment, this thermally reflective layer 6 is arranged directly on the outside 5 of the boot liner 1. Accordingly, when the heating element 3 is heated, very much less heat is radiated outwards, as a result of which especially the heating period for reaching the thermoplastic deformation temperature TV is reduced. Also, during normal heating operation, that is to say during heated use of the boot liner 1, this thermally reflective outer layer 6 reduces the energy consumption because outward radiation of unused thermal energy is reduced, which of course also improves the life of a battery 13 possibly used as source of current 12 (see FIGS. 3 and 4).

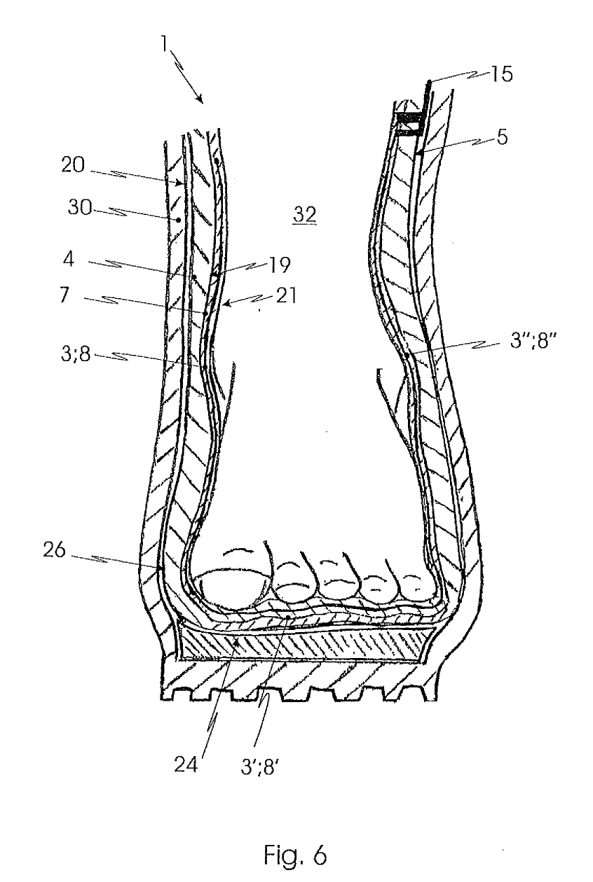

Finally, FIG. 6 shows a fourth embodiment, also in partial section, the boot liner 1 having already been inserted in an outer boot 30 in this case too. The boot liner 1 in this case is made of a basic material 4, to the inside 19 of which there has been applied an inner lining 7. In the main regions, this inner lining 7 is in contact with the wearer's foot 32.

In this embodiment, the electrical heating element 3 is integrated into the inner lining 7, the electrically conductive threads 8 in this case having been so woven together with non-conductive threads that there is formed an inner lining 7 which in sub-regions is electrically heatable and in other sub-regions is merely electrically conductive. In this context, the use of additional covering layers is also feasible, which are arranged especially between the foot 32 at the inner lining 7 in order to increase comfort during wear and in addition to ensure electrical insulation of the electrical heating element. Explicit reference is made here to EP 1 705 956 A1, which belongs to the Applicant.

By way of example, there is furthermore shown here a connection element 15 which can be reached from the outside 5 of the boot liner 1 and especially also from the outside of the outer boot 30 and by way of which a source of current can be connected to the electrical heating element 3.

1.-13. (canceled)

14. A boot liner comprising:
a sub-region made of a material that is plastically deformable at a predetermined deformation temperature; and
one of a woven and a knitted electrical heating element associated with the sub-region and configured to heat the sub-region to the predetermined deformation temperature.

15. The boot liner of claim 14, wherein the one of the woven and the knitted heating element is configured to heat the sub-region to a lower comfort temperature between about 25 to 35 degrees Celsius.

16. The boot liner of claim 14, wherein the one of the woven and the knitted electrical heating element includes an electrically conductive thread material in the form of one of a wire and cords.

17. The boot liner of claim 16, wherein the one of the wire and the cords is incorporated into a heating element carrier fabric.

18. The boot liner of claim 16, wherein the one of the woven and the knitted electrical heating element includes at least one heating region and at least one current-conducting region, wherein the at least one current-conducting region is configured to connect the one of the woven and the knitted electrical heating element to a source of current, wherein the electrically conductive thread material is incorporated into the heating element carrier fabric in a greater density in the at least one current-conducting region than in the at least one heating region.

19. The boot liner of claim 18, wherein the one of the woven and the knitted electrical heating element includes a plurality of heating regions, wherein the current conducting region is configured to connect the plurality of heating regions.

20. The boot liner of claim 14, wherein the one of the woven and the knitted electrical heating element includes a plurality of heating regions distributed over the boot liner, wherein the plurality of heating regions include an electrically conductive thread material incorporated in the plurality of heating regions in varying density.

21. The boot liner of claim 16, wherein the one of the woven and the knitted electrical heating element includes a plurality of independent heating circuits formed from the electrically conductive thread material, wherein the electrically conductive thread material is configured to connect to a source of current.

22. The boot liner of claim 16, wherein the electrically conductive thread material includes at least one of natural and synthetic fibers.

23. The boot liner of claim 16, wherein the electrically conductive thread material includes metal additions.

24. The boot liner of claim 16, wherein the electrically conductive thread material does not include either metal threads or metal fibers.

25. The boot liner of claim 14, further comprising a source of current that includes one of a battery and a cable connected transformer, wherein the one of the woven and the knitted electrical heating element includes at least one heating region and at least one current-conducting region, wherein the at least one current conducting region is configured to connect the one of the woven and the knitted electrical heating element to the source of current, wherein the at least one current-conducting region includes a connection element disposed outside of the boot liner and is configured to connect to the source of current.

26. The boot liner of claim 25, further comprising an attachment device on the boot liner configured to attach to the source of current.

27. The boot liner of claim 14, further comprising at least one of an open-loop and a closed-loop control device integrated in the boot liner configured to control the predetermined deformation temperature.

28. The boot liner of claim 14, wherein the boot liner includes a mutli-layer basic material, wherein the one of the woven and the knitted electrical heating element is integrated into the multi-layer basic material.

29. The boot liner of claim 14, further comprising a textile inner lining, wherein the one of the woven and the knitted electrical heating element is integrated into the textile inner lining.

30. The boot liner of claim 14, further comprising a thermally insulating thermally reflective layer disposed between the one of the woven and the knitted electrical heating element and an outside of the boot liner.
